(19) United States
(12) Patent Application Publication
(10) Pub. No.: US 2026/0064209 A1
(43) Pub. Date: Mar. 5, 2026

(54) SENSOR SELECTION FOR PLANE DETECTION

(71) Applicant: Apple Inc., Cupertino, CA (US)

(72) Inventors: Aitor Aldoma Buchaca, Munich, Bavaria (DE); Oliver T Ruepp, Baierbrunn (DE)

(21) Appl. No.: 19/305,042

(22) Filed: Aug. 20, 2025

Related U.S. Application Data
(60) Provisional application No. 63/690,886, filed on Sep. 5, 2024.

(51) Int. Cl. G06F 3/0346; G01V 7/04; G06V 20/20

(52) U.S. Cl. CPC G06F 3/0346; G01V 7/04; G06V 20/20

(57) ABSTRACT

Various implementations disclosed herein include devices, systems, and methods that use a gravity direction to select a subset of sensors to determine plane characteristics. For example, a process may include obtaining first sensor data from sensors of an HMD and based on the first sensor data a gravity direction is determined. The process may further select a subset of the sensors based on the gravity direction. The process may further obtain second sensor data from the subset and determine characteristics of the physical environment based on the second sensor data.

### CROSS-REFERENCE TO RELATED APPLICATIONS

This application claims the benefit of U.S. Provisional Application Ser. No. 63/690,886 filed Sep. 5, 2024, which is incorporated herein in its entirety.

### TECHNICAL FIELD

The present disclosure generally relates to systems, methods, and devices that that use device and sensor orientation information relative to a direction of gravity to select a subset of device sensors to use to determine ground plane characteristics.

### BACKGROUND

Existing wearable device-based systems for detecting obstacles, surfaces, and other environmental characteristics may be improved with respect to simplicity, safety, and accuracy.

### SUMMARY

Various implementations disclosed herein include systems, methods, and devices that use head-mounted device (HMD) and/or sensor orientation information relative to a direction of gravity to select sensors for use in determining ground plane characteristics. In some implementations, a direction of gravity may be used to select sensors for use in determining any type of plane (in an environment) having a relationship to a direction of gravity. For example, in addition to a ground plane, a direction of gravity may be used to detect a ceiling plane by ignoring or disabling bottom facing sensors/data and only using or enabling top scene facing sensors. Likewise, a direction of gravity may be used to detect wall planes by ignoring or disabling bottom and top facing cameras and using forward facing and/or side facing cameras).

In some implementations, HMD and/or sensor orientation information may be determined based on sensor data obtained from, inter alia, a gyroscope, an accelerometer, etc.

In some implementations, a subset of sensors may be selected from a group of sensors of an HMD to determine ground plane characteristics such as, inter alia, a ground plane location, a ground plane orientation, room boundaries, obstacles, etc. The subset of sensors may be selected based on how well individual sensors are expected to sense and capture ground characteristics given an orientation of the HMD and/or sensors while a user is wearing the HMD within a physical environment. For example, a subset of sensors, such as downward-facing cameras, may be selected when an HMD or sensor is in an upright position relative to a direction of gravity. Likewise, a subset of sensors such as outward-facing sensors may be selected when the HMD or sensor is tilted in a forward position relative to a direction of gravity. In some implementations, an alternative subset of sensors may be selected when a user wearing the HMD is lying down (e.g., on a floor) and the HMD is positioned with respect to another orientation relative to a direction of gravity.

In some implementations, sensors of an HMD may be selected to identify an orientation, location, boundaries, etc. of a floor surface. In some implementations, sensors of an HMD may be selected to detect obstacles with respect to a floor surface such as, boxes, a chair, a negative obstacle such as stairs going down, etc.

In some implementations, HMD or sensor orientation information may be used to restrict a ground plane search space with respect to an expectation that a ground plane will have an orientation that is substantially perpendicular, parallel, or not parallel to a gravity direction within a specified margin of error. Restricting a ground plane search space may result in compute resource savings such as, inter alia, central processing unit (CPU), memory, power, graphical processing unit (GPU), etc.

In some implementations, using only a subset of sensors instead of all sensors may potentially save power and/or compute resources.

In some implementations, a direction of gravity may be determined in a sensor's coordinate system so that a direction may be mapped to all other sensors in the coordinate system (e.g., cameras). Subsequently, it may be determined, for example, which cameras are looking downwards. Likewise, a set of cameras may be selected to extract floor-related information. For example, determining a gravity direction with respect to a first sensor (e.g., an IMU sensor, an accelerometer, a camera, etc.) of sensors an HMD enables the determined direction of gravity relative to the first sensor to be transformed to a second sensor of the sensors (e.g., a camera) through a simple rigid coordinate transform. The aforementioned sensor transform allows the process to determine a direction of the second. For example, if the second sensor is a camera, it may be determined if the camera is facing up or down and an associated angle without having to do any complex image processing. Subsequently, a camera that faces towards a floor may subsequently be selected for processing and a camera facing away from the floor does require consideration and therefore image processing for the camera facing away from the floor may be skipped.

In some implementations, an HMD has one or more sensors and a processor (e.g., one or more processors) that executes instructions stored in a non-transitory computer-readable medium to perform a method. The method performs one or more steps or processes. In some implementations, the HMD obtains first sensor data from the one or more sensors in a physical environment. In some implementations, based on the first sensor data, a direction of gravity is determined. In some implementations, a subset of the one or more sensors is selected based on the direction of gravity. In some implementations, second sensor data is obtained from the subset. In some implementations, characteristics of the 3D environment are determined based on the second sensor data.

In some implementations, the subset of sensors may be selected based on predicting that the subset will capture sensor data corresponding to a ground or any plane of the physical environment better than one or more of the other sensors not included in the subset.

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 illustrates exemplary electronic devices operating in a physical environment, in accordance with some implementations.

FIG. 2 illustrates an example environment that includes users each wearing a wearable device comprising an upright orientation relative to a gravity direction, in accordance with some implementations.

FIG. 3 illustrates an example environment that includes users each wearing a wearable device comprising a tilted orientation relative to a gravity direction, in accordance with some implementations.

FIG. 4 illustrates an example environment that includes users each wearing a wearable device comprising an alternative orientation relative to a gravity direction, in accordance with some implementations.

FIG. 5 illustrates an example environment for implementing a process for determining HMD orientation information relative to a direction of gravity to select sensors for use in determining ground plane characteristics, in accordance with some implementations.

FIG. 6 is a flowchart representation of an exemplary method that determines an orientation of a HMD relative to a gravity direction to select a subset of sensors to use to determine ground plane characteristics, in accordance with some implementations.

FIG. 7 is an example electronic device in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

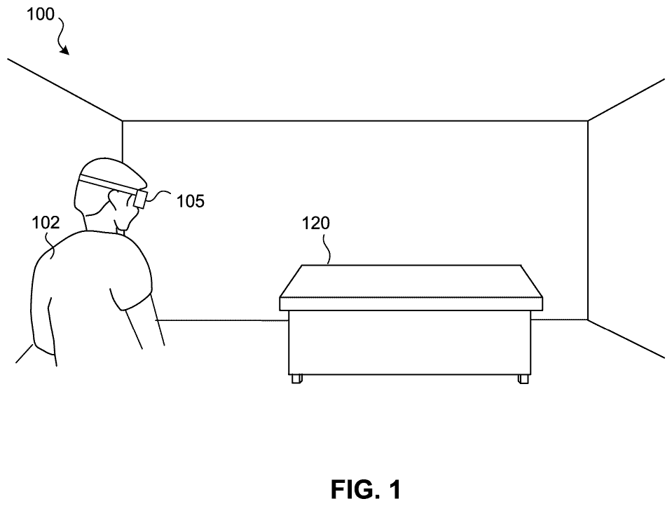

FIG. 1 illustrates an exemplary electronic device 105 operating in a physical environment 100. In the example of FIG. 1, the physical environment 100 is a room that includes a desk 120. The electronic device 105 may include one or more cameras, microphones, depth sensors, or other sensors that can be used to capture information about and evaluate the physical environment 100 and the objects within it, as well as information about the user 102 of electronic device 105. The information about the physical environment 100 and/or user 102 may be used to provide visual and audio content and/or to identify the current location of the physical environment 100 and/or the location of the user within the physical environment 100.

In some implementations, views of an extended reality (XR) environment may be provided to one or more participants (e.g., user 102 and/or other participants not shown) via electronic device 105 (e.g., a wearable device such as an HMD). Such an XR environment may include views of a 3D environment that is generated based on camera images and/or depth camera images of the physical environment 100 as well as a representation of user 102 based on camera images and/or depth camera images of the user 102. Such an XR environment may include virtual content that is positioned at 3D locations relative to a 3D coordinate system associated with the XR environment, which may correspond to a 3D coordinate system of the physical environment 100.

In some implementations, first sensor data may be obtained from sensors of an HMD (e.g., device 105) while a user (e.g., user 102) is wearing the HMD within a physical environment (e.g., physical environment 100). For example, sensors of the HMD may include, inter alia, a gyroscope, an accelerometer, a camera(s), etc. Camera types may include a downward facing camera, an outward facing camera, an inward facing camera, etc.

In some implementations, an orientation of the HMD and/or a sensor of the HMD with respect to a direction of gravity is determined based on analysis of the first sensor data.

In some implementations, a subset of the sensors is selected based on the determined orientation of the HMD and/or a sensor of the HMD. The subset of sensors may be selected based on predicting that the subset will capture sensor data corresponding to a ground (e.g., a ground surface, a floor surface, etc.) of the physical environment better than other sensors that are not included in the subset of sensors. For example, the subset of sensors may be selected based on determining which sensors are expected to capture the most amount of and/or a highest quality data (e.g., a highest resolution) regarding a ground surface, a floor surface, etc. In some implementations, a subset of sensors may include a single sensor. In some implementations, a subset of sensors may include multiple sensors.

In some implementations, second sensor data (e.g., RGB, depth data, etc.) may be obtained from the subset of sensors while the electronic device being worn by the user is within the physical environment. For example, a direction of gravity may be determined in a sensor's coordinate system so that a direction may be mapped to all other sensors in the coordinate system (e.g., cameras). Subsequently, it may be determined, for example, which cameras are looking downwards. Likewise, a set of cameras may be selected to extract floor-related information. For example, determining a gravity direction with respect to a first sensor (e.g., an IMU sensor, an accelerometer, a camera, etc.) of sensors an HMD enables the determined direction of gravity relative to the first sensor to be transformed to a second sensor of the sensors (e.g., a camera) through a simple rigid coordinate transform. The aforementioned sensor transform allows the process to determine a direction of the second. For example, if the second sensor is a camera, it may be determined if the camera is facing up or down and an associated angle without having to do any complex image processing. Subsequently, a camera that faces towards a floor may subsequently be selected for processing and a camera facing away from the floor does require consideration and therefore image processing for the camera facing away from the floor may be skipped.

In some implementations, the second sensor data is analyzed to determine characteristics of the physical environment based on the second sensor data. For example, characteristics of the physical environment may include, inter alia, ground plane orientation, ground plane position, ground plane boundaries such as a transition between rooms, obstacles on a floor, a negative obstacle such as stairs going down, etc. In one example, the second sensor data includes one or more images (e.g., RGB, B/W, depth images, etc.) from a particular viewpoint given the device's current orientation and those one or more images depict a substantial portion of a flooring surface/ground plane. Such images may be analyzed via an algorithm or machine learning model trained to predict a 3D location of a flooring surface/ground plane, one or more of its boundaries, and/or to identify objects on such a flooring surface/ground plane that may be classified as having a particular type, e.g., as being obstacles, tripping hazards, immovable objects, barriers, walls, countertops, furniture, animals, pets, people, windows, doors, etc. Changes along or otherwise on a flooring surface/ground plane level may be detected via an algorithm or machine learning model and interpreted to identify locations of stairs (up or down), ramps, cliff edges, and/or uneven flooring surfaces, e.g., rocky surfaces, etc. Multiple adjacent flooring surfaces/ground planes detected to have different relative levels (e.g., heights relative to gravity) may be identified to detect one or more stairs.

In some implementations, an action associated with the characteristics of the physical environment may be executed. For example, warning may be enabled to notify a user that an obstacle exists so that the user may avoid a potential hazard.

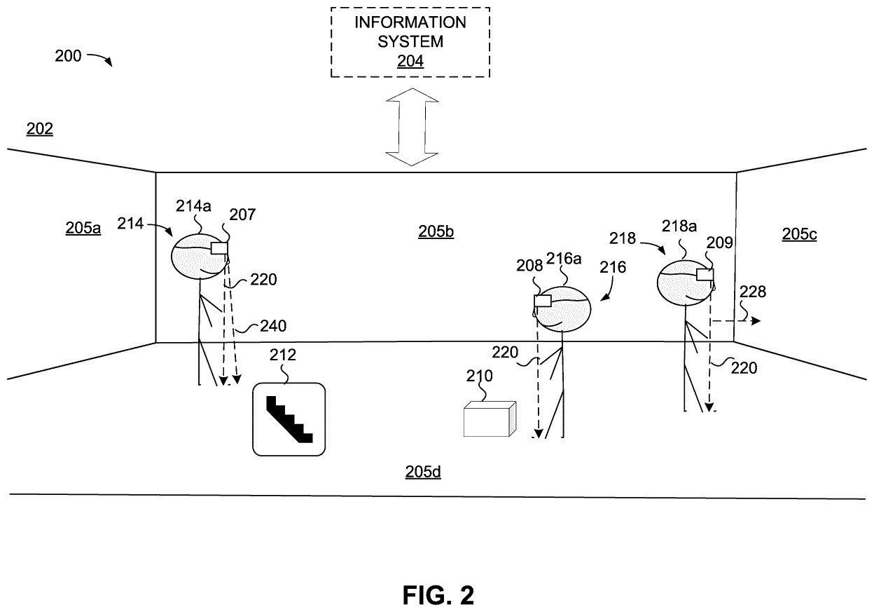

FIG. 2 illustrates an example of an environment 200 that includes users each wearing a wearable device with a sensor comprising an upright orientation relative to a gravity direction, in accordance with some implementations. For example, environment 200 illustrates: a user 214 wearing/operating a wearable device 207 with at least one sensor 211 in a physical environment 202, a user 216 wearing/operating a wearable device 208 (e.g., with a sensor such as sensor 211 of wearable device 207) in physical environment 202, and a user 218 wearing/operating a wearable device 209 (e.g., with a sensor such as sensor 211 of wearable device 207) in physical environment 202.

Additionally, environment 200 may include an information system 204 (e.g., a framework, server, controller or network) in communication with one or more of wearable devices 207, 208, and 209. In an exemplary implementation, wearable devices 207, 208, and 209 are communicating with each other and an intermediary device such as information system 204.

In some implementations, each of wearable devices 207, 208, and 209 includes an HMD configured to present views of an extended reality (XR) environment (e.g., a 3D scene), which may be based on the physical environment 202, and/or include added virtual content such as virtual objects.

In the example of FIG. 2, the physical environment 202 may be a room that includes walls 205a, 205b, and 205c, a floor 205d (e.g., the ground), and physical objects such as obstacles 210 and 212. In this instance, obstacles 210 and 212 may be physical objects or virtual objects.

In some implementations, each of wearable devices 207, 208, and 209 may include one or more sensors. For example, sensors may include, inter alia, a gyroscope, an accelerometer, cameras, microphones, depth sensors, motion sensors, optical sensors or other sensors that may be used to capture information about and evaluate the physical environment 202 or an XR environment and objects within it, as well as information about users 214, 216, and 218.

In the example of FIG. 2, a head 214a of user 214 is oriented in an upright position such that HMD 207 (being worn by user 214) and/or sensor 211 has an upright orientation (e.g., a bottom portion of HMD 207 is substantially parallel with floor 205d). Accordingly, sensor data (from sensors such as a gyroscope, an accelerometer, etc.) may be used to determine an orientation of HMD 207 and/or sensor 211 with respect to a gravity direction 220. The orientation of HMD 207 and/or sensor 211 with respect to gravity direction 220 may be used to select a subset of sensors (of sensors on HMD 207) to use to determine ground plane characteristics (e.g., ground plane location and/or orientation, room boundaries, obstacles, etc.) of floor 205d. In this instance, the subset of sensors include downward-facing cameras for obtaining sensor data corresponding to gravity direction 220 (i.e., without having to determine the orientation of HMD 207) so that characteristics of the physical environment 202 may be obtained. For example, the downward-facing cameras may obtain image data indicating that there is an obstacle 212 (e.g., a negative obstacle such as stairs going down) within a path of movement of user 214. Accordingly, an action (a warning signal) may be initiated to present (to user 214) an indication that an obstacle exists so that the user 214 may avoid a potential hazard. In some implementations, the orientation of HMD 207 with respect to an offset direction 240 (e.g., a 3 degree offset with respect to gravity direction 220) may be used to select the subset of sensors (of sensors on HMD 207) to use to determine ground plane characteristics of floor 205d.

In some implementations, a ground plane may be detected for placing personas and/or objects on the ground plane. Likewise, a detected ground plane may be used to enable a visual search such as, inter alia, only searching for walls if user 214 is querying an object on the wall, object detection, etc.

In some implementations, cameras or sensors of HMD 207 may be selected based on gravity direction 220 without having to determine the orientation of HMD 207.

In some implementations, a direction of gravity may be used to select sensors for use in determining any type of plane (in an environment) having a relationship to a direction of gravity. For example, in addition to a ground plane, a direction of gravity may be used to detect a ceiling plane by ignoring or disabling bottom facing sensors/data and only using or enabling top scene facing sensors. Likewise, a direction of gravity may be used to detect wall planes by ignoring or disabling bottom and top facing cameras and using forward facing and/or side facing cameras).

In the example of FIG. 2, a head 216a of user 216 is oriented in an upright position such that HMD 208 (being worn by user 216) has an upright orientation (e.g., a bottom portion of HMD 208 is substantially parallel with floor 205d). Accordingly, sensor data (from sensors such as a gyroscope, an accelerometer, etc.) may be used to determine an orientation of HMD 208 and/or a sensor with respect to gravity direction 220. The orientation of HMD 208 and/or sensor with respect to gravity direction 220 may be used to select a subset of sensors (of sensors on HMD 208) to use to determine ground plane characteristics (e.g., ground plane location and/or orientation, room boundaries, obstacles, etc.) of floor 205d. In this instance, the subset of sensors include downward-facing cameras for obtaining sensor data corresponding to gravity direction 220 so that characteristics of the physical environment 202 may be obtained. For example, the downward-facing cameras may obtain image data indicating that there is an obstacle 214 (e.g., a positive obstacle such as a box) within a path of movement of user 216. Accordingly, an action (a warning signal) may be initiated to present (to user 216) an indication that an obstacle exists so that the user 216 may avoid a potential hazard.

In the example of FIG. 2, a head 218a of user 218 is oriented in an upright position such that HMD 209 (being worn by user 218) and/or a sensor has an upright orientation (e.g., a bottom portion of HMD 209 is substantially parallel with floor 205d). Accordingly, sensor data (from sensors such as a gyroscope, an accelerometer, etc.) may be used to determine an orientation of HMD 209 and/or sensor with respect to gravity direction 220. The orientation of HMD 209 with respect to gravity direction 220 may be used to select a subset of sensors (of sensors on HMD 209) to use to determine ground plane characteristics (e.g., ground plane location and/or orientation, etc.) of floor 205d. In this instance, the subset of sensors include downward-facing cameras for obtaining sensor data corresponding to gravity direction 220 so that characteristics of the physical environment 202 may be obtained. In some implementations, the orientation of HMD 209 with respect to gravity direction 220 may be used to restrict a plane search space with respect to an expectation that a plane (e.g., wall 205c) will have an orientation with respect to a direction 228 that is perpendicular, parallel, or not parallel to gravity direction 220. For example, the downward-facing cameras may obtain image data indicating that wall 205c (i.e., an obstacle perpendicular to gravity direction 220) is within a path of movement of user 218. Accordingly, an action (a warning signal) may be initiated to present (to user 218) an indication that wall 205c exists within a path of movement of user 218 so that the user 218 may avoid a potential hazard.

In some implementations, restricting a ground plane search space may result in compute resource savings such as, inter alia, central processing unit (CPU), memory, power, graphical processing unit (GPU), etc. In some implementations, using only a subset of sensors (e.g., of sensors on HMD 209) instead of all sensors may potentially save power and/or compute resources.

In some implementations, gravity direction 220 may be used to select sensors for use in determining any type of plane (in an environment) having a relationship to gravity direction 220. For example, in addition to a ground plane, a direction of gravity may be used to detect a ceiling plane by ignoring or disabling bottom facing sensors/data and only using or enabling top scene facing sensors. Likewise, a direction of gravity may be used to detect wall planes by ignoring or disabling bottom and top facing cameras and using forward facing and/or side facing cameras).

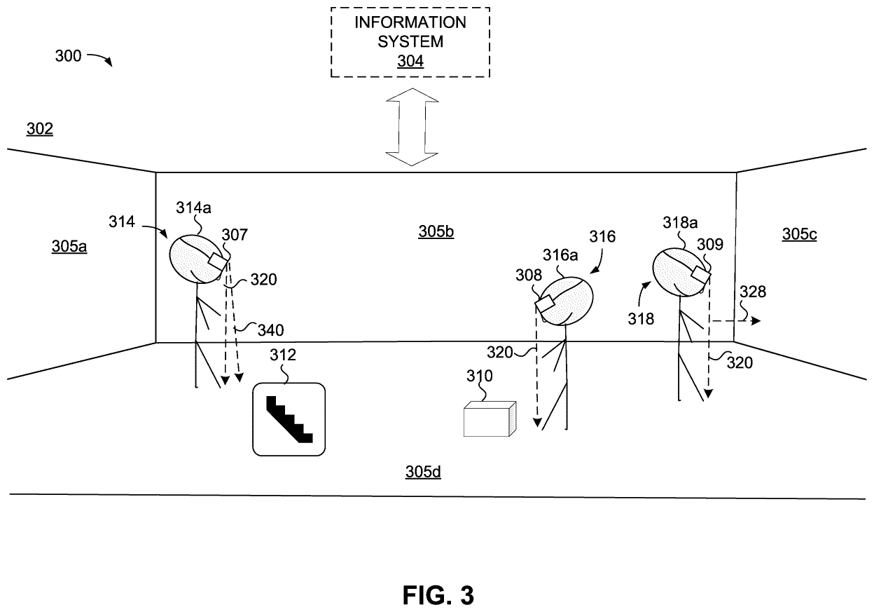

FIG. 3 illustrates an example of an environment 300 that includes users each wearing a wearable device comprising a tilted orientation relative to a gravity direction, in accordance with some implementations. For example, environment 300 illustrates: a user 314 wearing/operating a wearable device 307 in a physical environment 302, a user 316 wearing/operating a wearable device 308 in physical environment 302, and a user 318 wearing/operating a wearable device 309 in physical environment 302.

Additionally, environment 300 may include an information system 304 (e.g., a framework, server, controller or network) in communication with one or more of wearable devices 307, 308, and 309. In an exemplary implementation, wearable devices 307, 308, and 309 are communicating with each other and an intermediary device such as information system 304.

In some implementations, each of wearable devices 307, 308, and 309 includes an HMD configured to present views of an extended reality (XR) environment (e.g., a 3D scene), which may be based on the physical environment 302, and/or include added content such as virtual objects.

In the example of FIG. 3, the physical environment 302 may be a room that includes walls 305a, 305b, and 305c, a floor 305d (e.g., the ground), and physical objects such as obstacles 310 and 312. In this instance, obstacles 310 and 312 may be physical objects or virtual objects.

In some implementations, each of wearable devices 307, 308, and 309 may include one or more sensors. For example, sensors may include, inter alia, a gyroscope, an accelerometer, cameras, microphones, depth sensors, motion sensors, optical sensors or other sensors that may be used to capture information about and evaluate the physical environment 302 or an XR environment and objects within it, as well as information about users 314, 316, and 318.

In the example of FIG. 3, a head 314a of user 314 is oriented in a tilted downward position such that HMD 307 (being worn by user 314) has a tilted orientation (e.g., a bottom portion of HMD 307 has an angular position with respect to floor 305d). Accordingly, sensor data (from sensors such as a gyroscope, an accelerometer, etc.) may be used to determine an orientation of HMD 307 and/or a sensor 311 with respect to a gravity direction 320. The orientation of HMD 307 and/or a sensor 311 with respect to gravity direction 320 may be used to select a subset of sensors (of sensors on HMD 307) to use to determine ground plane characteristics (e.g., ground plane location and/or orientation, room boundaries, obstacles, etc.) of floor 305d. In this instance, the subset of sensors include outward-facing cameras (e.g., initiating a view from a front portion of the HMD 307 in contrast with downward facing cameras) for obtaining sensor data corresponding to gravity direction 320 so that characteristics of the physical environment 302 may be obtained. For example, the outward-facing cameras may obtain image data indicating that there is an obstacle 312 (e.g., a negative obstacle such as stairs going down) within a path of movement of user 314. Accordingly, an action (a warning signal) may be initiated to present (to user 314) an indication that an obstacle exists so that the user 314 may avoid a potential hazard. In some implementations, the orientation of HMD 307 with respect to an offset direction 340 (e.g., a 3 degree offset with respect to gravity direction 320) may be used to select the subset of sensors (of sensors on HMD 307) to use to determine ground plane characteristics of floor 305d.

In some implementations, cameras or sensors of HMD 307 may be selected based on gravity direction 320 without having to determine the orientation of HMD 307.

In some implementations, a direction of gravity may be used to select sensors for use in determining any type of plane (in an environment) having a relationship to a direction of gravity. For example, in addition to a ground plane, a direction of gravity may be used to detect a ceiling plane by ignoring or disabling bottom facing sensors/data and only using or enabling top scene facing sensors. Likewise, a direction of gravity may be used to detect wall planes by ignoring or disabling bottom and top facing cameras and using forward facing and/or side facing cameras).

In the example of FIG. 3, a head 316a of user 316 is oriented in a tilted downward position such that HMD 308 (being worn by user 316) has a tilted orientation (e.g., a bottom portion of HMD 308 has an angular position with respect to floor 305d). Accordingly, sensor data (from sensors such as a gyroscope, an accelerometer, etc.) may be used to determine an orientation of HMD 308 and/or a sensor with respect to gravity direction 320. The orientation of HMD 308 with respect to gravity direction 320 may be used to select a subset of sensors (of sensors on HMD 308) to use to determine ground plane characteristics (e.g., ground plane location and/or orientation, room boundaries, obstacles, etc.) of floor 305d. In this instance, the subset of sensors include outward-facing cameras for obtaining sensor data corresponding to gravity direction 320 so that characteristics of the physical environment 302 may be obtained. For example, the outward-facing cameras may obtain image data indicating that there is an obstacle 314 (e.g., a positive obstacle such as a box) within a path of movement of user 316. Accordingly, an action (a warning signal) may be initiated to present (to user 316) an indication that an obstacle exists so that the user 316 may avoid a potential hazard.

In the example of FIG. 3, a head 318a of user 318 is oriented in a tilted downward position such that HMD 309 (being worn by user 318) has a tilted orientation (e.g., a bottom portion of HMD 309 has an angular position with respect to floor 305d). Accordingly, sensor data (from sensors such as a gyroscope, an accelerometer, etc.) may be used to determine an orientation of HMD 309 and/or a sensor with respect to gravity direction 320. The orientation of HMD 309 and/or sensor with respect to gravity direction 320 may be used to select a subset of sensors (of sensors on HMD 309) to use to determine ground plane characteristics (e.g., ground plane location and/or orientation, etc.) of floor 305d. In this instance, the subset of sensors include outward-facing cameras for obtaining sensor data corresponding to gravity direction 320 so that characteristics of the physical environment 302 may be obtained. In some implementations, the orientation of HMD 309 and/or sensor with respect to gravity direction 320 may be used to restrict a ground plane search space with respect to an expectation that a ground plane (e.g., wall 305c) will have an orientation with respect to a direction 328 that is perpendicular, parallel, or not parallel to gravity direction 320. For example, the outward-facing cameras may obtain image data indicating that wall 305c (i.e., an obstacle perpendicular to gravity direction 320) is within a path of movement of user 318. Accordingly, an action (a warning signal) may be initiated to present (to user 318) an indication that wall 305c exists within a path of movement of user 318 so that the user 318 may avoid a potential hazard.

In some implementations, restricting a ground plane search space may result in compute resource savings such as, inter alia, central processing unit (CPU), memory, power, graphical processing unit (GPU), etc. In some implementations, using only a subset of sensors (e.g., of sensors on HMD 309) instead of all sensors may potentially save power and/or compute resources.

In some implementations, a ground plane may be identified for placing objects on, for example, a floor in a realistic manner. For example, a spatially accurate user representation may be on the ground plane.

Likewise, while FIG. 3 refers to detecting a ground plane, alternative planes may be detected such as, for example, a ceiling plane, a wall plane, etc. using the same approaches.

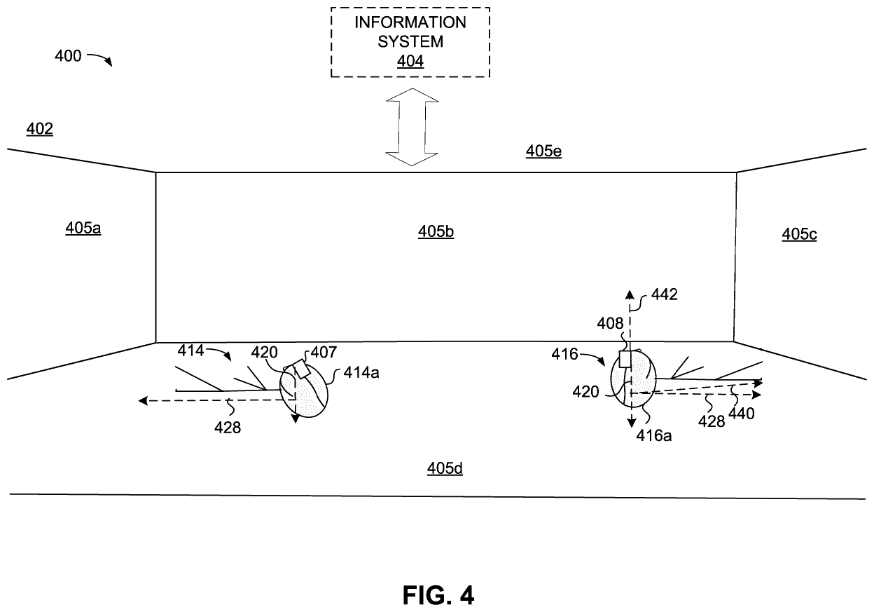

FIG. 4 illustrates an example environment 400 that includes users each wearing a wearable device (with a sensor) comprising an alternative orientation relative to a gravity direction, in accordance with some implementations. For example, example environment 400 illustrates: a user 414 wearing/operating a wearable device 407 with a sensor 411 in a physical environment 402 and a user 416 wearing/operating a wearable device 408 in physical environment 402.

Additionally, example environment 400 may include an information system 404 (e.g., a framework, server, controller or network) in communication with one or more of wearable devices 407 and 408. In an exemplary implementation, wearable devices 407 and 408 are communicating with each other and an intermediary device such as information system 404.

In some implementations, each of wearable devices 407 and 408 includes an HMD configured to present views of an extended reality (XR) environment (e.g., a 3D scene), which may be based on the physical environment 402, and/or include added content such as virtual objects.

In the example of FIG. 4, the physical environment 402 may be a room that includes walls 405a, 405b, and 405c, a floor 405d (e.g., the ground), a ceiling 405e and physical objects such as obstacles 410 and 412. In this instance, obstacles 410 and 412 may be physical objects or virtual objects.

In some implementations, each of wearable devices 407 and 408 may include one or more sensors (e.g., sensor 411). For example, sensors may include, inter alia, a gyroscope, an accelerometer, cameras, microphones, depth sensors, motion sensors, optical sensors or other sensors that may be used to capture information about and evaluate the physical environment 402 or an XR environment and objects within it, as well as information about users 414 and 416.

In the example of FIG. 4, user 414 is laying down (e.g., in a substantially horizontal/parallel position with respect to floor 405d) and a head 414a of user 414 is oriented in a tilted downward position such that HMD 407 (being worn by user 414) and sensor 411 has a tilted orientation (e.g., a bottom portion of HMD 407 has an angular position with respect to floor 405d or wall 405a). Accordingly, sensor data (from sensors such as a gyroscope, an accelerometer, etc.) may be used to determine an orientation of HMD 407 and/or sensor 411 with respect to a gravity direction 420. The orientation of HMD 407 and/or sensor 411 with respect to gravity direction 420 may be used to select a subset of sensors (of sensors on HMD 407) to use to determine ground plane characteristics (e.g., ground plane location and/or orientation, room boundaries, etc.) of floor 405d. In this instance, the subset of sensors include downward-facing cameras for obtaining sensor data corresponding to gravity direction 420 so that characteristics of the physical environment 402 may be obtained. In some implementations, the orientation of HMD 407 with respect to gravity direction 420 may be used to restrict a ground plane search space with respect to an expectation that a ground plane (e.g., wall 405a) will have an orientation with respect to a direction 428 that is perpendicular, parallel, or not parallel to gravity direction 420.

In some implementations, restricting a ground plane search space may result in compute resource savings such as, inter alia, central processing unit (CPU), memory, power, graphical processing unit (GPU), etc. In some implementations, using only a subset of sensors (e.g., of sensors on HMD 407) instead of all sensors may potentially save power and/or compute resources.

In the example of FIG. 4, user 416 is laying down (e.g., in a substantially horizontal/parallel position with respect to floor 405d) and a head 416a of user 416 has an orientation such that a front portion of HMD 408 is facing ceiling 405 and a back portion of HMD 408 is facing floor 405d. Accordingly, sensor data (from sensors such as a gyroscope, an accelerometer, etc.) may be used to determine an orientation of HMD 408 and/or sensor or the HMD with respect to gravity direction 420 and/or direction 442 (opposite to gravity direction 420). The orientation of HMD 408 and/or sensor with respect to gravity direction 420 and/or direction 442 may be used to select a subset of sensors (of sensors on HMD 408) to use to determine ground plane characteristics (e.g., ground plane location and/or orientation, room boundaries, etc.) of floor 405d, ceiling 405e, and/or wall 405c. In this instance, the subset of sensors include outward-facing cameras for obtaining sensor data corresponding to gravity direction 420 and/or direction 442 (opposite to gravity direction 420) so that characteristics of the physical environment 402 may be obtained (e.g., characteristics of ceiling 405e and/or floor 405d). In some implementations, the orientation of HMD 408 with respect to gravity direction 420 and or direction 442 may be used to restrict a ground plane search space with respect to an expectation that a ground plane (e.g., wall 405c) will have an orientation with respect to a direction 428 that is perpendicular, parallel, or not parallel to gravity direction 420 and direction 442. In some implementations, the orientation of HMD 408 with respect to an offset direction 440 (e.g., a 3 or 4 degree offset with respect to direction 428) may be used to select the subset of sensors (of sensors on HMD 408) to use to determine ground plane characteristics of wall 405c.

In some implementations, cameras or sensors of HMD 408 may be selected based on gravity direction 420 without having to determine the orientation of HMD 408.

In some implementations, a direction of gravity may be used to select sensors for use in determining any type of plane (in an environment) having a relationship to a direction of gravity. For example, in addition to a ground plane, a direction of gravity may be used to detect a ceiling plane by ignoring or disabling bottom facing sensors/data and only using or enabling top scene facing sensors. Likewise, a direction of gravity may be used to detect wall planes by ignoring or disabling bottom and top facing cameras and using forward facing and/or side facing cameras).

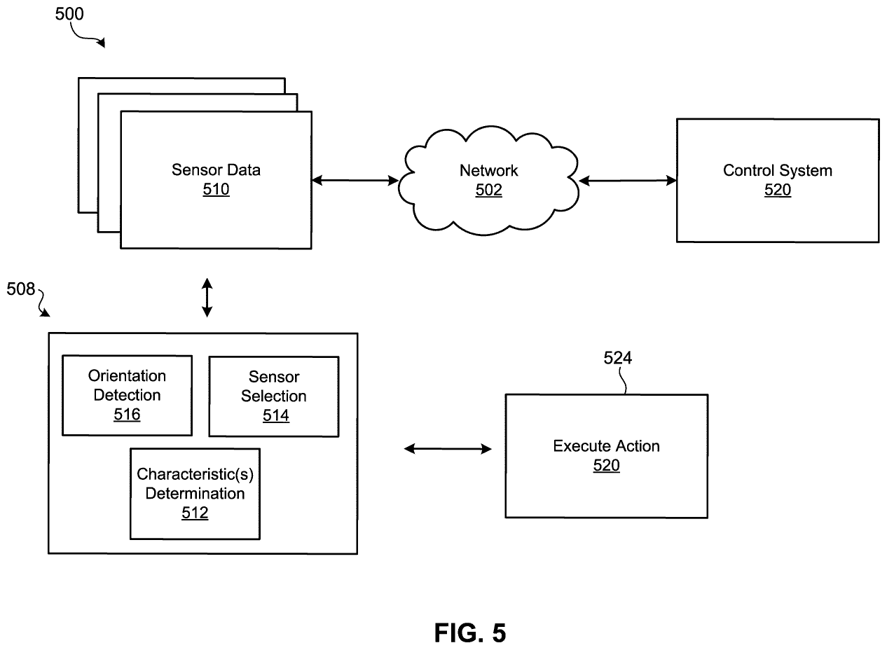

FIG. 5 illustrates an example environment 500 for implementing a process for determining HMD and/or sensor orientation information relative to a direction of gravity to select sensors for use in determining ground plane characteristics, in accordance with some implementations. The example environment 500 includes sensor data 510, tools/software 508, an action execution module 520, and a control system 520 (e.g., information system 104 of FIG. 1) that, in some implementations, communicates over a data communication network 502, e.g., a local area network (LAN), a wide area network (WAN), the Internet, a mobile network, or a combination thereof. In some implementations, tools/software 508 includes an orientation detection module 516, a sensor selection module, and a characteristic(s) determination module.

In some implementations, sensor data 510 (e.g., from a gyroscope, an accelerometer, cameras, etc.) is obtained and in response, orientation detection module 516 is configured to determine an orientation of an HMD and/or a sensor of the HMD with respect to a direction of gravity, Subsequently, sensor selection module 514 executes a process for selecting a subset of sensors (from a group of sensors of the HMD) to determine ground plane characteristics (e.g., of a physical and/or virtual environment) such as, inter alia, a ground plane location, a ground plane orientation, room boundaries, obstacles, etc. In some implementations, the subset of sensors may include, inter alia, downward-facing cameras selected when an HMD is in an upright position with respect to a direction of gravity, outward-facing sensors selected when the HMD is tilted in a forward position with respect to a direction of gravity. Alternative sensors may be selected when a user wearing the HMD is lying down (e.g., on a floor) and the HMD and/or sensor is positioned with respect to differing orientations relative to a direction of gravity, etc.

In some implementations, sensors of an HMD may be selected to identify characteristics the physical and/or virtual environment (via characteristic(s) determination module 512) such as an orientation, location, boundaries, etc. of a floor surface, obstacles with respect to a floor surface such as, boxes, a chair, a negative obstacle such as stairs going down, etc.

In some implementations, execute action module 520 may be enabled to execute an action associated with the characteristics of the physical environment. For example, execute action module 520 may be enabled to generate and present (to a user of the HMD) a warning that an obstacle exists so that the user may adjust a path of movement accordingly.

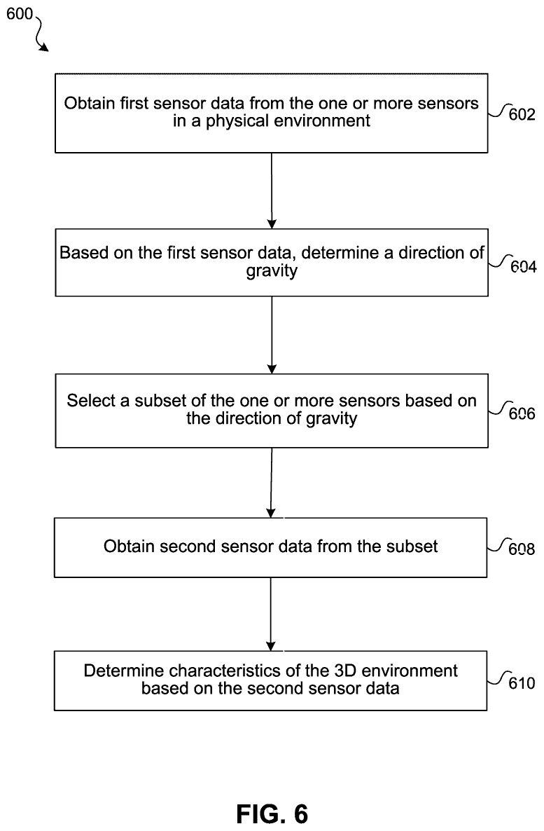

FIG. 6 is a flowchart representation of an exemplary method 600 that determines to a gravity direction to select a subset of sensors to use to determine plane characteristics, in accordance with some implementations. In some implementations, the method 600 is performed by a device, such as a wearable device. In some implementations, the device has a screen for displaying images and/or a screen for viewing stereoscopic images such as a head-mounted display (HMD such as e.g., device 105 of FIG. 1). In some implementations, the method 600 is performed by processing logic, including hardware, firmware, software, or a combination thereof. In some implementations, the method 600 is performed by a processor executing code stored in a non-transitory computer-readable medium (e.g., a memory). Each of the blocks in the method 600 may be enabled and executed in any order.

At block 602, the method 600 obtains first sensor data from one or more sensors of an HMD in a physical environment. For example, sensor data may be obtained from a wearable device 207 being worn by a user 214 in a physical environment 202 as described with respect to FIG. 2.

In some implementations, the one or more sensors includes an accelerometer.

In some implementations, the one or more sensors includes a gyroscope in combination with an accelerometer.

In some implementations, the one or more sensors includes a camera in combination with an accelerometer.

At block 604, the method 600, determines (based on the first sensor data of the HMD) a direction of gravity. For example, a head 214a of user 214 is oriented in an upright position such that HMD 207 (being worn by user 214) and/or sensor 211 has an upright orientation (e.g., a bottom portion of HMD 207 is substantially parallel with floor 205d as described with respect to FIG. 2.

In some implementations, an orientation of the HMD and/or sensor may be determined and used to restrict a search space associated with the ground with respect to a prediction that an orientation of the ground plane (e.g., its normal) is parallel or not parallel to the direction of gravity within a specified margin of error. For example, an orientation of an HMD 209 and/or sensor with respect to gravity direction 220 may be used to restrict a ground plane search space with respect to an expectation that a ground plane (e.g., wall 205c) will have an orientation with respect to a direction 228 that is perpendicular, parallel or not parallel to gravity direction 220 as described with respect to FIG. 2. In some implementations, restricting a ground plane search space may result in compute resource savings such as, inter alia, central processing unit (CPU), memory, power, graphical processing unit (GPU), etc. In some implementations, using only a subset of sensors (e.g., of sensors on HMD 209) instead of all sensors may potentially save power and/or compute resources.

At block 606, the method 600 selects a subset of the one or more sensors based on the direction of gravity. For example, an orientation of an HMD 307 or associated sensor 311 with respect to a gravity direction 320 may be used to select a subset of sensors (of sensors on HMD 307) to use to determine ground plane or any plane characteristics (e.g., ground plane location and/or orientation, room boundaries, obstacles, etc.) of a floor 305d as described with respect to FIG. 3.

In some implementations, the subset of sensors may be selected based on predicting that the subset will capture sensor data corresponding to a ground of the physical environment better than one or more of the other sensors not included in the subset. In some implementations, the subset of sensors selection may be performed by selectively enabling the subset of sensors while allowing all other sensors to remain disabled to save power. Alternatively in some implementations, the subset of sensors selection may be performed by selecting sensor data of only sensors configured to perform scene understanding tasks to save computational cost or power.

In some implementations, the subset of sensors may include downward-facing sensors selected based on determining that the HMD is oriented in an upright position relative to the direction of gravity as described with respect to FIG. 2.

In some implementations, the subset of sensors may include outward-facing sensors selected based on determining that the HMD is oriented in a tilted forward position relative to the direction of gravity as described with respect to FIG. 2.

In some implementations, the subset of sensors may include specified sensors selected in response to determining that the user is in a horizontal position (e.g., lying down) with respect to the ground and the HMD is oriented in an alternative position relative to the direction of gravity. For example, a user 414 laying down (e.g., in a substantially horizontal/parallel position with respect to a floor 405d) and a head 414a of a user 414 being oriented in a tilted downward position such that an HMD 407 (being worn by user 414) has a tilted orientation (e.g., a bottom portion of HMD 407 has an angular position with respect to floor 405d or wall 405a) as described with respect to FIG. 4.

In some implementations, the subset of the one or more sensors may include a single sensor.

In some implementations, the subset of the one or more sensors may include a plurality of sensors.

At block 608, the method 600 obtains second sensor data from the subset of sensors. For example, the subset of sensors may include outward-facing cameras for obtaining sensor data corresponding to a gravity direction 320 as described with respect to FIG. 3.

In some implementations, the second sensor data may include RGB data, depth data, etc.

At block 610, the method 600 determines characteristics of the physical environment based on the second sensor data. For example, outward-facing cameras may obtain image data indicating that there is an obstacle 312 (e.g., a negative obstacle such as stairs going down) within a path of movement of a user 314 as described with respect to FIG. 3.

In some implementations, characteristics of the physical environment include ground plane or any plane characteristics of the ground, walls, ceiling, etc. In some implementations, plane characteristics may include a ground plane location, a ground plane orientation, boundaries between rooms of a physical environment, obstacles (e.g., a box on the floor, a threshold between rooms, a negative obstacle such as stairs going down, etc.) in a physical environment, etc.

In some implementations, an action associated with the characteristics of the physical environment may be executed. For example, an action such as a warning signal may be initiated to present (to a user 314) an indication that an obstacle exists so that the user 314 may avoid a potential hazard as described with respect to FIG. 3.

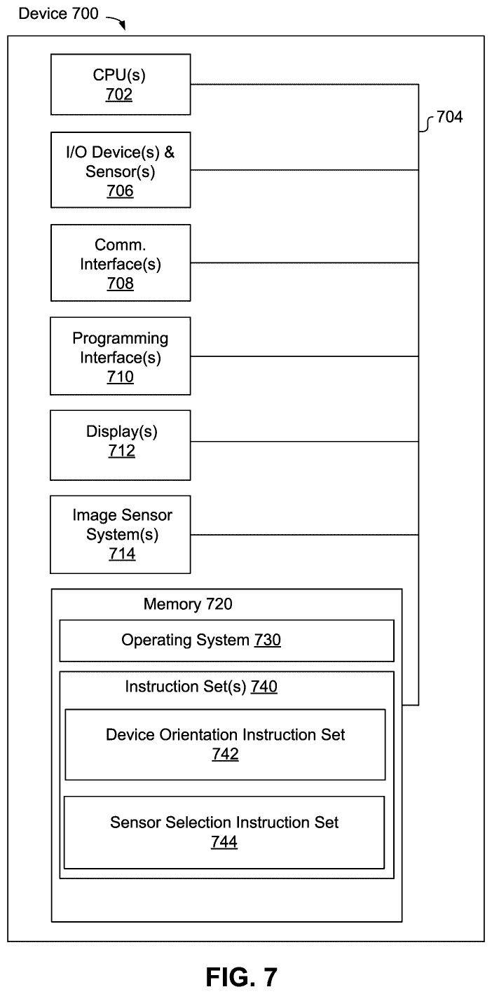

FIG. 7 is a block diagram of an example device 700. Device 700 illustrates an exemplary device configuration for electronic devices 105, 112, 115a, 115b, 115c, 115d, and 116 of FIG. 1. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the device 700 includes one or more processing units 702 (e.g., microprocessors, ASICs, FPGAs, GPUs, CPUs, processing cores, and/or the like), one or more input/output (I/O) devices and sensors 706, one or more communication interfaces 708 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, SPI, 12C, and/or the like type interface), one or more programming (e.g., I/O) interfaces 710, one or more displays 712, one or more interior and/or exterior facing image sensor systems 714, a memory 720, and one or more communication buses 704 for interconnecting these and various other components.

In some implementations, the one or more communication buses 704 include circuitry that interconnects and controls communications between system components. In some implementations, the one or more I/O devices and sensors 706 include at least one of an inertial measurement unit (IMU), an accelerometer, a magnetometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some implementations, the one or more displays 712 are configured to present a view of a physical environment or a graphical environment to the user. In some implementations, the one or more displays 712 are configured to present content (determined based on a determined user/object location of the user within the physical environment) to the user. In some implementations, the one or more displays 712 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some implementations, the one or more displays 712 correspond to diffractive, reflective, polarized, holographic, etc. waveguide displays. In one example, the device 700 includes a single display. In another example, the device 700 includes a display for each eye of the user.

In some implementations, the one or more image sensor systems 714 are configured to obtain image data that corresponds to at least a portion of the physical environment 105. For example, the one or more image sensor systems 714 include one or more RGB cameras (e.g., with a complimentary metal-oxide-semiconductor (CMOS) image sensor or a charge-coupled device (CCD) image sensor), monochrome cameras, IR cameras, depth cameras, event-based cameras, and/or the like. In various implementations, the one or more image sensor systems 714 further include illumination sources that emit light, such as a flash. In various implementations, the one or more image sensor systems 714 further include an on-camera image signal processor (ISP) configured to execute a plurality of processing operations on the image data.

In some implementations, sensor data may be obtained by device(s) (e.g., devices 105 and 110 of FIG. 1) during a scan of a room of a physical environment. The sensor data may include a 3D point cloud and a sequence of 2D images corresponding to captured views of the room during the scan of the room. In some implementations, the sensor data includes image data (e.g., from an RGB camera), depth data (e.g., a depth image from a depth camera), ambient light sensor data (e.g., from an ambient light sensor), and/or motion data from one or more motion sensors (e.g., accelerometers, gyroscopes, IMU, etc.). In some implementations, the sensor data includes visual inertial odometry (VIO) data determined based on image data. The 3D point cloud may provide semantic information about one or more elements of the room. The 3D point cloud may provide information about the positions and appearance of surface portions within the physical environment. In some implementations, the 3D point cloud is obtained over time, e.g., during a scan of the room, and the 3D point cloud may be updated, and updated versions of the 3D point cloud obtained over time. For example, a 3D representation may be obtained (and analyzed/processed) as it is updated/adjusted over time (e.g., as the user scans a room).

In some implementations, sensor data may be positioning information, some implementations include a VIO to determine equivalent odometry information using sequential camera images (e.g., light intensity image data) and motion data (e.g., acquired from the IMU/motion sensor) to estimate the distance traveled. Alternatively, some implementations of the present disclosure may include a simultaneous localization and mapping (SLAM) system (e.g., position sensors). The SLAM system may include a multidimensional (e.g., 3D) laser scanning and range-measuring system that is GPS independent and that provides real-time simultaneous location and mapping. The SLAM system may generate and manage data for a very accurate point cloud that results from reflections of laser scanning from objects in an environment. Movements of any of the points in the point cloud are accurately tracked over time, so that the SLAM system can maintain precise understanding of its location and orientation as it travels through an environment, using the points in the point cloud as reference points for the location.

In some implementations, the device 700 includes an eye tracking system for detecting eye position and eye movements (e.g., eye gaze detection). For example, an eye tracking system may include one or more infrared (IR) light-emitting diodes (LEDs), an eye tracking camera (e.g., near-IR (NIR) camera), and an illumination source (e.g., an NIR light source) that emits light (e.g., NIR light) towards the eyes of the user. Moreover, the illumination source of the device 700 may emit NIR light to illuminate the eyes of the user and the NIR camera may capture images of the eyes of the user. In some implementations, images captured by the eye tracking system may be analyzed to detect position and movements of the eyes of the user, or to detect other information about the eyes such as pupil dilation or pupil diameter. Moreover, the point of gaze estimated from the eye tracking images may enable gaze-based interaction with content shown on the near-eye display of the device 700.

The memory 720 includes high-speed random-access memory, such as DRAM, SRAM, DDR RAM, or other random-access solid-state memory devices. In some implementations, the memory 720 includes non-volatile memory, such as one or more magnetic disk storage devices, optical disk storage devices, flash memory devices, or other non-volatile solid-state storage devices. The memory 720 optionally includes one or more storage devices remotely located from the one or more processing units 702. The memory 720 includes a non-transitory computer readable storage medium.

In some implementations, the memory 720 or the non-transitory computer readable storage medium of the memory 720 stores an optional operating system 730 and one or more instruction set(s) 740. The operating system 730 includes procedures for handling various basic system services and for performing hardware dependent tasks. In some implementations, the instruction set(s) 740 include executable software defined by binary information stored in the form of electrical charge. In some implementations, the instruction set(s) 740 are software that is executable by the one or more processing units 702 to carry out one or more of the techniques described herein.

The instruction set(s) 740 includes a device/sensor orientation instruction set 742 and a sensor selection instruction set 744. The instruction set(s) 740 may be embodied as a single software executable or multiple software executables.

The device orientation instruction set 742 is configured with instructions executable by a processor to determine (based on sensor data) an orientation of an HMD and/or sensor of the HMD with respect to a direction of gravity.

The sensor selection instruction set 744 is configured with instructions executable by a processor to select a subset of sensors based on the orientation of the HMD and/or sensor. The subset of sensors are used to provide sensor data for determining characteristics of a physical environment.

Although the instruction set(s) 740 are shown as residing on a single device, it should be understood that in other implementations, any combination of the elements may be located in separate computing devices. Moreover, FIG. 7 is intended more as functional description of the various features which are present in a particular implementation as opposed to a structural schematic of the implementations described herein. As recognized by those of ordinary skill in the art, items shown separately could be combined and some items could be separated. The actual number of instructions sets and how features are allocated among them may vary from one implementation to another and may depend in part on the particular combination of hardware, software, and/or firmware chosen for a particular implementation.

Those of ordinary skill in the art will appreciate that well-known systems, methods, components, devices, and circuits have not been described in exhaustive detail so as not to obscure more pertinent aspects of the example implementations described herein. Moreover, other effective aspects and/or variants do not include all of the specific details described herein. Thus, several details are described in order to provide a thorough understanding of the example aspects as shown in the drawings. Moreover, the drawings merely show some example embodiments of the present disclosure and are therefore not to be considered limiting.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, e.g., one or more modules of computer program instructions, encoded on computer storage medium for execution by, or to control the operation of, data processing apparatus. Alternatively, or additionally, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures. Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, and/or broken into sub-blocks. Certain blocks or processes can be performed in parallel. The operations described in this specification can be implemented as operations performed by a data processing apparatus on data stored on one or more computer-readable storage devices or received from other sources.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

What is claimed is:

1. A method comprising:
at a head mounted device (HMD) having a processor and one or more sensors:
obtaining first sensor data from the one or more sensors in a physical environment;
based on the first sensor data, determining a direction of gravity
selecting a subset of the one or more sensors based on the direction of gravity;
obtaining second sensor data from the subset; and
determining characteristics of the physical environment based on the second sensor data.

2. The method of claim 1, wherein the characteristics of the physical environment comprise ground plane characteristics of the ground.

3. The method of claim 2, wherein the ground plane characteristics comprise a ground plane location.

4. The method of claim 2, wherein the ground plane characteristics comprise a ground plane orientation.

5. The method of claim 2, wherein the ground plane characteristics comprise boundaries between rooms of the physical environment.

6. The method of claim 2, wherein the ground plane characteristics comprise obstacles in the physical environment.

7. The method of claim 1, wherein the subset comprises downward-facing sensors selected based on determining that a sensor of the one or more sensors is oriented in an upright position relative to the direction of gravity.

8. The method of claim 1, wherein the subset comprises outward-facing sensors selected based on determining that a sensor of the one or more sensors is oriented in a tilted forward position relative to the direction of gravity.

9. The method of claim 1, wherein the subset comprises specified sensors selected in response to determining that a user is in a horizontal position with respect to a plane and a sensor of the one or more sensors is oriented in an alternative position relative to the direction of gravity.

10. The method of claim 1, wherein the orientation of the sensor is used to restrict a search space associated with a plane with respect to a prediction that an orientation of the plane is parallel to the direction of gravity within a specified margin of error.

11. The method of claim 1, wherein an orientation of a sensor of the one or more sensors is used to restrict a search space associated with a plane with respect to a prediction that an orientation of the plane is not parallel to the direction of gravity within a specified margin of error.

12. The method of claim 1, wherein the subset of the one or more sensors comprises a single sensor.

13. The method of claim 1, wherein the subset of the one or more sensors comprises a plurality of sensors.

14. The method of claim 1, wherein the one or more sensors comprises an accelerometer.

15. The method of claim 14, wherein the one or more sensors comprises a gyroscope.

16. The method of claim 14, wherein the one or more sensors comprises a camera.

17. The method of claim 14, wherein the second sensor data comprises RGB data.

18. The method of claim 14, wherein the second sensor data comprises depth data.

19. The method of claim 1, further comprising:
executing an action associated with the characteristics of the physical environment.

20. The method of claim 1, further comprising:
determining an orientation of a first sensor of the one or more sensors with respect to the direction of gravity relative to the first sensor.

21. The method of claim 1, wherein the subset is selected based on predicting that the subset will capture sensor data corresponding to a plane of the physical environment better than one or more of the other sensors not included in the subset.

22. A head mounted device (HMD) comprising:
a non-transitory computer-readable storage medium;
one or more sensors; and
one or more processors coupled to the non-transitory computer-readable storage medium, wherein the non-transitory computer-readable storage medium comprises program instructions that, when executed on the one or more processors, cause the electronic device to perform operations comprising:
obtaining first sensor data from the one or more sensors in a physical environment;
based on the first sensor data, determining a direction of gravity;
selecting a subset of the one or more sensors based on the direction of gravity;
obtaining second sensor data from the subset; and
determining characteristics of the physical environment based on the second sensor data.

23. A non-transitory computer-readable storage medium, storing program instructions executable by one or more processors to perform operations comprising:
at a head mounted device (HMD) having a processor and one or more sensors:
obtaining first sensor data from the one or more sensors in a physical environment;
based on the first sensor data, determining a direction of gravity;
selecting a subset of the one or more sensors based on the direction of gravity;
obtaining second sensor data from the subset; and
determining characteristics of the physical environment based on the second sensor data.
